(19) United States
(12) Patent Application Publication
(10) Pub. No.: US 2005/0268169 A1
(43) Pub. Date: Dec. 1, 2005

(54) Method and system for editing logical programmes for trouble diagnostics

(76) Inventors: Jari Paanasalo, Jarvenpaa (FI); Timo Virtanen, Espoo (FI)

Correspondence Address: STIENNON & STIENNON, 612 W. MAIN ST., SUITE 201, P.O. BOX 1667, MADISON, WI, 53701-1667, US

(21) Appl. No.: 11/119,477

(22) Filed: Apr. 29, 2005

(30) Foreign Application Priority Data
Apr. 30, 2004 (FI) 20040624

(51) Int. Cl. G06F 11/00

(52) U.S. Cl. 714/30

(57) ABSTRACT

The invention concerns a method and a system for editing logical programs for a trouble diagnostic system, which trouble diagnostic system is used to determine and locate trouble in industrial processes and/or equipment, and which trouble diagnostic system comprises logical circuits (L) consisting of a set of circuit components (L₁, . . . , Lₙ) arranged at several different processing levels. In the method according to the invention, logical circuits (L) are edited into such a form, that the resulting logical circuit can be presented in a simple form in the trouble diagnostic system. The system according to the invention comprises means for editing logical circuits (L), whereby the resulting logical circuit can be presented in a simple form in the trouble diagnostic system.

### CROSS REFERENCES TO RELATED APPLICATIONS

This application claims priority on Finnish App. No. 20040624, filed Apr. 30, 2004, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention concerns a method and system for editing logical programs for a trouble diagnostic system, which trouble diagnostic system is used to determine and locate trouble in industrial processes and/or equipment, and which trouble diagnostic system comprises a logical program/logical programs comprising logical circuits, which consist of a set of circuit components arranged at several different processing levels.

Industrial processes and equipment are usually controlled by Programmable Logic Controllers, PLC, whose operation is based on algorithms based on Boolean algebra. Boolean algebra is based on processing of binary signals by logical operators, which are, for example, AND-, OR- and NOT-operations. By combining binary signals and these operations it is possible by using logical circuits to bring about the desired control signals.

Programmable logical programs are used to bring about displays, which are used, for example, in diagnostic systems of industrial processes and which show the locking functions preventing the desired motion in the monitored system. In such displays, OR circuits, for example, can be displayed in such a way that locking functions of the OR circuit are not shown, if some of the OR circuit's signals is in the OK state.

For editing logical circuits and logical programs various methods have been developed to find out why a signal is in a certain state. Even very complicated chains of operations are often needed in practice. These chains of operations cannot be presented by the display programs in use today, because these allow a simple presentation only, which can be understood by a user not profoundly knowledgeable about logical programs.

As regards the state of the art to do with the invention, reference is made to printed public specification EP-0 753 168, which presents an automatic method for diagnosing trouble. According to said method, processes or equipment are monitored by a logical program's sequence control in such a way that the contact plan or function plan of the trouble diagnostic system is converted into a list of instructions, which is analyzed mechanically by phase chain analysis. In the phase chain analysis, the phase chains used in the program code are identified and they are localized automatically. The phase chains are then prepared in knowledge base form and the topmost decision level of the trouble tree is deduced from it. Those signals, which have led to stopping of the process or equipment, are determined by the trouble diagnostic program.

### SUMMARY OF THE INVENTION

The objective of the invention is to present a method and a system in trouble diagnostics, by which method and system it is possible to present signals processed by multi-level logical circuits in a user-friendly and easily interpreted form in the display unit of a trouble diagnostic system.

The method according to the invention is mainly characterized in that logical circuits are edited into such a reduced form, that the resulting logical circuit can be presented in a simple form in a trouble diagnostic system.

The system according to the invention is mainly characterized in that the system comprises means for editing logical circuits, whereby the resulting reduced logical circuit can be presented in a simple form in a trouble diagnostic system.

According to the invention, multi-level logical circuits can be presented in a simple display window in such a way that the multi-level logical circuit is edited by using algorithms based on Boolean algebra into no more than two-level form. When edited in this manner, the logical circuit remaining for presentation is either an AND circuit comprising individual signals and simple/single-level OR circuits or an OR circuit comprising individual signals and simple/single-level AND circuits. The functioning of such a logical circuit can be presented in a simple display window in such a manner that no profound knowledge of complicated logical circuits is required for its interpretation. This feature of the invention improves considerably the usability of the trouble diagnostic software in a complicated production system.

According to an advantageous application example of the invention, the multi-level logical circuit is analyzed step by step, and as the outcome of the analysis the logical circuit is reduced by combining logical operations. The number of levels is hereby reduced after each step. The steps of analysis and combination are repeated, until no more than a two-level logical circuit remains as the result. A logical circuit of this kind can be presented in state-of-the-art simple display windows of trouble diagnostic systems.

The invention is suitable for use in any industrial process or equipment systems, wherein trouble diagnostic systems are used, and preferably in equipment of the paper industry, in mineral-treatment systems of the process industry as well as in automation applications of various kinds. The invention allows better utilization for trouble diagnostic programs using multi-level logical circuits.

The invention can easily be applied to already existing trouble diagnostic systems of the industries. By utilizing the invention it is possible automatically and quickly to analyze complicated logical circuits, whose analyzing used to require a considerable manual input of labor. In addition, the trouble diagnostic system becomes considerably more covering than before, because better knowledge is obtained of the functioning of complicated logical circuits.

In the following, the invention will be described in greater detail by referring to the figures in the appended drawings, but it is not an intention to limit the invention narrowly to any details of these figures.

### BRIEF DESCRIPTION OF THE DRAWINGS

FIG. 1 shows an example of a state-of-the-art display window in a diagnostic system.

FIG. 2 shows an example of a multi-level logical circuit.

FIG. 3A shows an example of a logical circuit converted into a conjunctive normal form (Product Of Sums, POS).

FIG. 3B shows an example of a logical circuit converted into a disjunctive normal form (Sum Of Products, SOP).

FIG. 4 shows in flow chart form an algorithm for converting a multi-level logical circuit into a two-level form.

FIG. 5 shows step by step how a multi-level logical circuit is converted into a two-level form.

### DESCRIPTION OF THE PREFERRED EMBODIMENTS

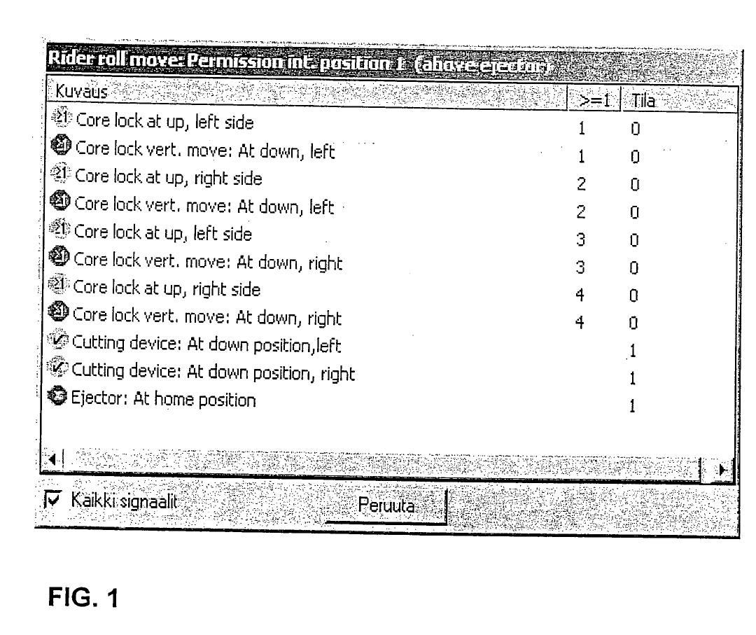

FIG. 1 shows an example of a state-of-the-art display window in a diagnostic system, presenting the state of motional condition of the rider roll of a slitter-winder in a papermaking machine in the initial state of reeling, that is, in a situation where the rider roll is in the lower position. The heading of the display window is Rider roll move: Permission int. position 1 (above ejector) and various locking signals are presented on each line of the display window. A symbol at the beginning of each line corresponding to each locking signal shows whether the mentioned locking is in the presented state (cross symbol x), in the OK state (hook symbol √) or whether the signal belongs to an OR circuit (symbol ≧1). In the right-hand column of the window it is shown to which OR circuit each signal belongs and which is the state of each signal. For example, the first line of the display window shows a Core lock at up, left side locking, which belongs to the OR circuit 1 and is in the 0 state. The following lines first show other states of the core lock and after these on the third and second to last lines the states of the cutting device in the lower position left identifier and right identifier. The last line shows the state of the ejector at home position.

Locking states can also be shown, for example, in colors or in some other distinct visual manner, from which the user can easily see the state of the system. A simple manner of presentation of this kind provides the user with information on the functioning of the system without any need for the user to have profound knowledge of the structure of the system.

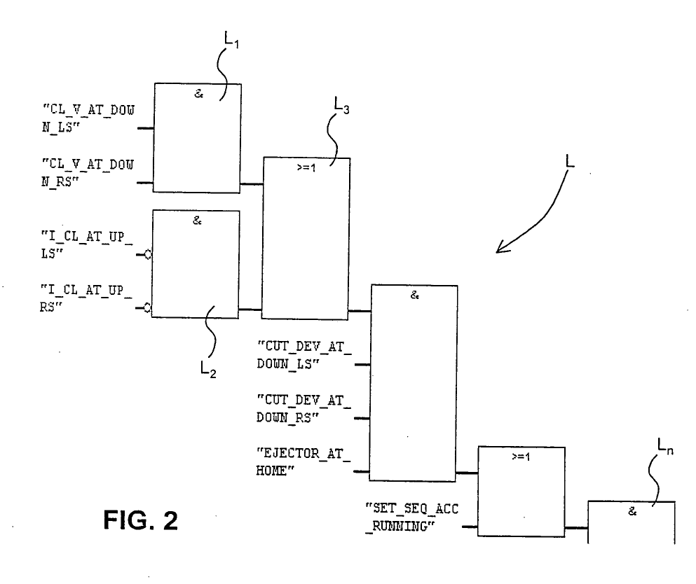

FIG. 2 shows an example of a multi-level logical circuit L, wherein several logical operations are made on binary signals in circuit components L₁, . . . , Lₙ located at different levels. Each circuit component L₁, . . . , Lₙ performs a logical operation on the entering binary signals. For example, logical circuit component L₁ performs on the binary signals a CL_V_AT_DOWN_LS and a CL_V_AT_DOWN_RS AND operation illustrated by the symbol &, and logical circuit component L₃ performs on the output signals of logical circuit components L₁ and L₂ an OR operation illustrated by the symbol>=1. The multi-level logical circuit L according to FIG. 2 cannot be presented as such in the display window of a trouble diagnostic system according to FIG. 1.

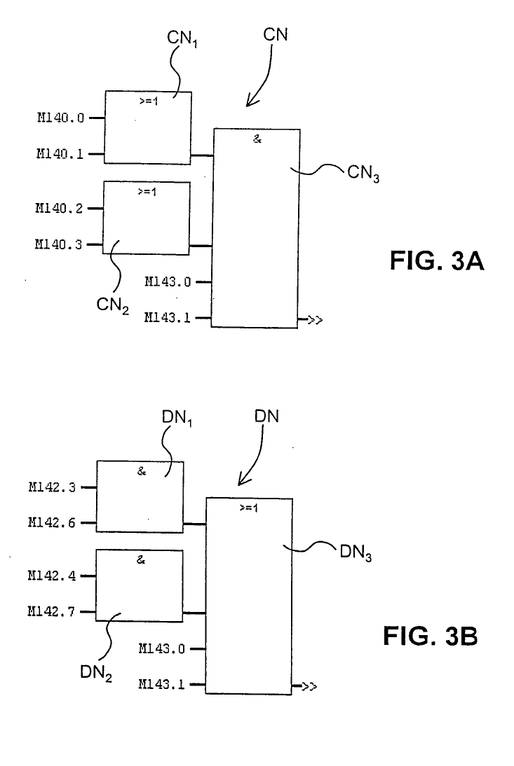

FIG. 3A shows an example of a logical circuit CN in a conjunctive normal form (Product Of Sums, POS) and comprising an AND circuit having individual signals and OR circuits. Signals M140.0 and M140.1 are brought to the OR circuit CN₁ and signals M140.2 and M140.3 are brought to the OR circuit CN₂. The outputs of circuits CN₁ and CN₂ as well as the signals M143.0 and M143.1 are brought to the circuit CN₃, which provides as output a binary signal produced by the logical circuit CN.

FIG. 3B shows an example of a logical circuit DN in a disjunctive normal form (Sum Of Products, SOP) and comprising an OR circuit having individual signals and AND circuits. Signals M142.3 and M142.6 are brought to the AND circuit DN1 and signals M142.4 and M1 42.7 are brought to the AND circuit DN₂. The outputs of circuits DN₁ and DN₂ as well as the signals M143.0 and M143.1 are brought to circuit DN₃, which provides as output a binary signal produced by the logical circuit DN.

The logical circuits CN, DN shown in FIGS. 3A and 3B are in such a two-level form, which can be presented in a trouble diagnostic display window according to FIG. 1.

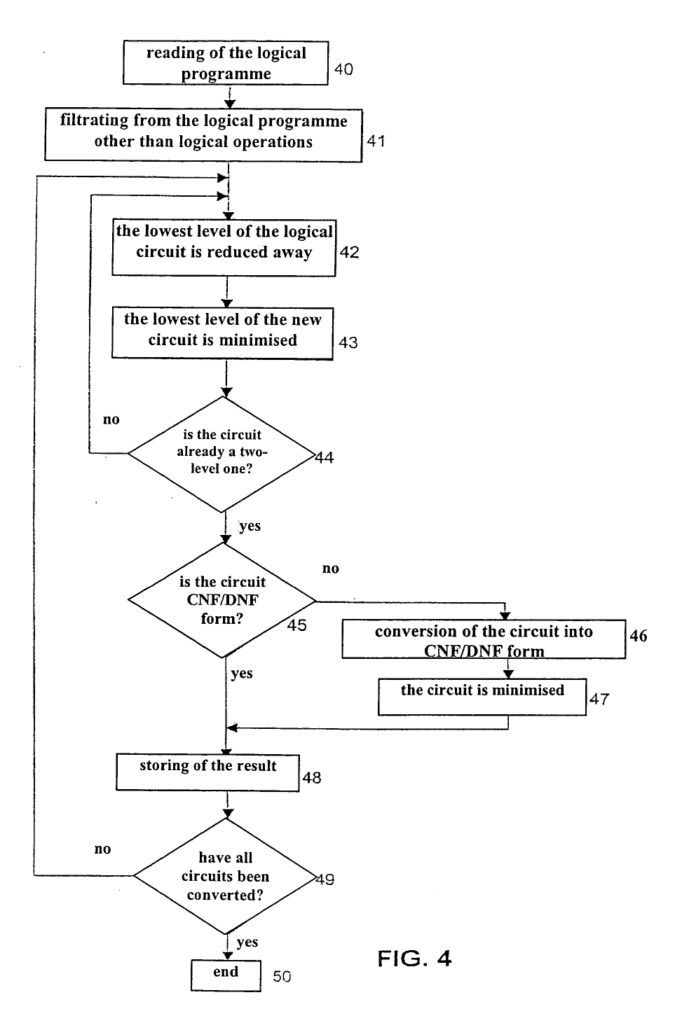

With the aid of FIG. 4 an algorithm will be presented in the following, which illustrates an advantageous embodiment of the invention. The algorithm in FIG. 4 shows an optional conversion of a circuit into a conjunctive normal form CNF or into a disjunctive normal form DNF.

With the aid of the algorithm of FIG. 4, multi-level logical circuits are edited into the mentioned two-level forms. To begin with in step 40, the logical program to be edited is read into the editing program according to the invention, and in step 41 other than logical operations are filtered away from the logical program. In step 42, the lowest level is filtered away from the logical circuit and in step 43 the lowest level of the new logical circuit thus resulting is minimized. A check is made in step 44 to find out whether the circuit to be edited after the preceding steps is a two-level one. If the logical circuit is not yet a two-level one, the operation moves from the algorithm back to step 42, where the logical circuit is reduced, and to step 43, where the logical circuit is minimized. If as a result of the editing the logical circuit is a two-level one in step 44, the operation moves on to step 45, where a check is made to find out whether the logical circuit is in a conjunctive normal form or in a disjunctive normal form. If the logical circuit is not in the desired form, the operation moves on to step 46, where the logical circuit is converted into a conjunctive or a disjunctive normal form. The logical circuit is minimized in step 47. If in step 45 the logical circuit was already in a conjunctive normal form CNF or in a disjunctive normal form DNF, the operation moves on directly to step 48, wherein the result is stored with an algorithm according to the invention. A check is made in step 49 to find out whether all the circuits in the logical program have been converted into the desired form. If there are still non-converted circuits, the operation moves to step 42 and the algorithm is performed again, until all the circuits of the logical program have been converted. Finally, the operation moves to finishing of the algorithm in step 50.

In advantageous alternatives of carrying out the invention, the logical circuits to be edited are converted into a conjunctive or a disjunctive normal form. In addition, according to the invention, the final form may be a disjunctive normal form DNF comprising an OR circuit comprising either individual signals and/or simple/single-level AND circuits, or a conjunctive normal form CNF comprising an AND circuit comprising either individual signals and/or simple/single-level OR circuits.

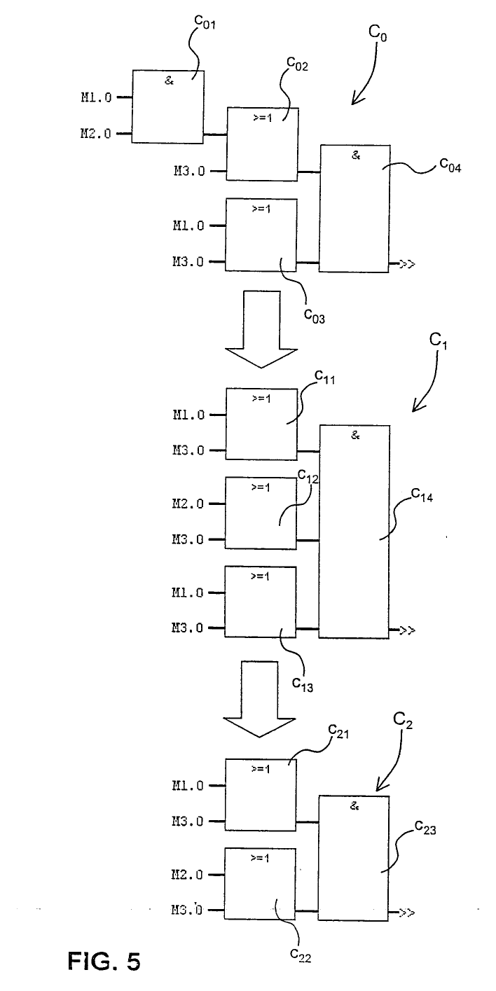

FIG. 5 illustrates application of the algorithm shown in FIG. 4 in the conversion of a logical circuit into a two-level conjunctive normal form, that is, into CNF form. In the first step, the original logical circuit C₀ is a three-level logical circuit comprising a circuit component c₀₁ which is an AND circuit, circuit components c₀₂ and c₀₃, which are OR circuits, and a circuit component c₀₄, which is an AND circuit. After the first conversion, which corresponds to steps 40-42 of the algorithm shown in FIG. 4, the logical circuit under editing has been converted into form C₁. The logical circuit C₁ comprises OR circuits c₁₁,c₁₂, which have been formed by combining the circuit components c₀₁ and c₀₂ of the original logical circuit C₀. The logical circuit C₁ also comprises an OR circuit C₁₃ and an AND circuit C₁₄. In the following step, the logical circuit under editing is minimized further into a final two-level CNF circuit by carrying out the steps 43-48 of the algorithm according to FIG. 4. The final two-level CNF circuit C₂ comprises OR circuits c₂₁ and c₂₂ as well as an AND circuit c₂₃.

The system according to the invention comprises means for implementation of the method according to the invention, that is, means for editing a logical circuit, whereby the resulting reduced logical circuit can be presented in a simple display window of a trouble diagnostic system. The logical circuit obtained as the result of the editing method may also be presented to the user as a printout, a speech message, in written form or in some other suitable form of presentation.

The system according to the invention preferably comprises means for editing, reducing, minimizing, storing and presenting a logical circuit. In an additional advantageous embodiment of the invention, the system also comprises means for converting the resulting logical circuits into a disjunctive or a conjunctive normal form.

According to the additional embodiment of the invention, the system also comprises means for converting the resulting logical circuits into a disjunctive normal form, which comprises an OR circuit comprising either individual signals and/or simple/single-level AND circuits or, alternatively, into a conjunctive normal form, which comprises an AND circuit comprising either individual signals and/or simple/single-level OR circuits.

In the foregoing, an advantageous embodiment was described for converting a logical circuit into said two-level form of presentation. A conversion in accordance with steps 42-48 of FIG. 4 can also be carried out, for example, by using Karnaugh's map, the Quine-McCluskey algorithm as well as other methods based on use of the truth table or other methods used for editing logical functions.

In the foregoing, the invention was described by referring only to some advantageous application examples of it, but it is not an intention to restrict the invention narrowly to the details of these. Many modifications and variations are possible within the scope of the inventive idea defined by the following claims.

1. A method for editing logical programs for a trouble diagnostic system comprising the steps of:
determining and locating trouble in industrial processes and/or equipment with the trouble diagnostic system, wherein the trouble diagnostic system comprises a logical program/logical programs comprising logical circuits, which comprise a set of circuit components arranged at several different processing levels;
editing the logical circuits in the trouble diagnostic system into a reduced form, to produce a resulting logical circuit; and
presenting the resulting logical circuit in a simple form.

2. The method of claim 1, wherein the step of editing the logical circuits further comprises:
selecting a logical circuit to be edited;
finding the logical circuit's lowest level, and reducing away said lowest level to form a new logical circuit;
finding the new logical circuit's lowest level and minimizing the lowest level of the new logical circuit; and
repeating the previous two steps until the logical circuit to be edited is a two-level logical circuit.

3. The method of claim 2 further comprising the steps of:
determining if the two-level logical circuit is of a normal form and if the two-level logical circuit is not of a normal form, converting the two-level logical circuit into a normal form;
storing the two-level logical circuit of a normal form; and
repeating the foregoing steps until all of the trouble diagnostic system's logical circuits have been converted into edited two-level logical circuits of a normal form.

4. The method of claim 1 wherein the step of editing the logical circuits in the trouble diagnostic system into a reduced from comprises editing the logical circuits into a disjunctive normal form.

5. The method of claim 1 wherein the step of editing the logical circuits in the trouble diagnostic system into a reduced from comprises editing the logical circuits into a conjunctive normal form.

6. The method of claim 1 wherein the step of editing the logical circuits in the trouble diagnostic system into a reduced from comprises editing the logical circuits into a disjunctive normal form comprising an OR circuit having either individual signals or simple/single-level AND circuits.

7. The method of claim 1 wherein the step of editing the logical circuits in the trouble diagnostic system into a reduced from comprises editing the logical circuits into a conjunctive normal form, which comprises an AND circuit comprising either individual signals or simple/single-level OR circuits.

8. The method of claim 1, wherein the resulting logical circuit in a simple form is presented to the user in a way selected from the group consisting in a display window, as a print-out, as a speech message, in written form.

9. An industrial equipment with a trouble diagnostic system comprising:
a plurality of logical circuits, having a set of circuit components arranged at several different processing levels and arranged to locate trouble in the equipment;
a means for editing logical circuits, having an out-put which is an edited version of the logical circuits, in a reduced form; and
means for presenting in a simple form the logical circuits, in the reduced form.

10. The industrial equipment of claim 9, further comprising:
means for reducing away the lowest level of the logical circuit being edited;
means for minimizing said lowest level of the logical circuit;
means for converting said logical circuit into a normal form; and
means for storing the resulting two-level logical circuit in the normal form.

11. The industrial equipment of claim 9, further comprising means for converting the edited version of the logical circuits in a reduced form into a disjunctive normal form.

12. The industrial equipment of claim 9, further comprising means for converting the edited version of the logical circuits in a reduced form into a conjunctive normal form.

13. The industrial equipment of claim 9, further comprising means for converting the edited version of the logical circuits in a reduced form into a disjunctive normal form, which comprises an OR circuit comprising either individual signals or simple/single-level AND circuits.

14. The industrial equipment of claim 9, further comprising means for converting the edited version of the logical circuits in a reduced form into a conjunctive normal form, which comprises an AND circuit comprising either individual signals or simple/single-level OR circuits.

15. The industrial equipment of claim 9 wherein the means for presenting is selected from the group consisting of a user display window, a print-out, a speech message, and, in written form.

16. A method for editing logical programs for determining and locating trouble in industrial processes and/or equipment comprising the steps of:
reading the logical program;
filtering from the logical program other than logical operations, leaving logical circuits, which comprise a set of circuit components arranged at several different processing levels;
selecting one of said logical circuits not previously selected;
reducing away the lowest level of the selected logic circuit, to form a new circuit having a lowest level;
minimizing the lowest level of the new circuit;
determining if the new circuit has more than two levels, and, if the new circuit has more than two levels, repeating the previous two steps;
determining if the new circuit is in the conjunctive normal form or the disjunctive normal form, if yes, storing the new circuit, if no, converting the new circuit into conjunctive normal form or disjunctive normal form, followed by minimizing the new circuit to form a result, and storing the result;
if all of the logical circuits have not been converted to a two level circuit in the conjunctive normal form, or the disjunctive normal form, then continue editing starting with the step of selecting one of said logical circuits not previously selected; and
if all of said logical circuits have been converted to a two level circuit in the conjunctive normal form, or the disjunctive normal form, then presenting the resulting logical circuit in a simple form to a user.
